(19) United States
(12) Patent Application Publication
(10) Pub. No.: US 2010/0171394 A1
(43) Pub. Date: Jul. 8, 2010

(54) ENERGY HARVESTING FOR IMPLANTED MEDICAL DEVICES

(76) Inventors: Richard A. Glenn, Santa Rosa, CA (US); Daniel W. Fifer, Windsor, CA (US); Michael S. Williams, Santa Rosa, CA (US)

Correspondence Address: SYNECOR LLC, P.O. BOX 5325, LARKSPUR, CA, 94977, US

(21) Appl. No.: 12/498,289

(22) Filed: Jul. 6, 2009

Related U.S. Application Data
(60) Provisional application No. 61/078,409, filed on Jul. 6, 2008.

(51) Int. Cl. H02N 2/18

(52) U.S. Cl. 310/339

(57) ABSTRACT

An energy harvesting device positionable within a blood vessel for use in generating energy for powering all or a portion of the functions of a diagnostic or therapeutic medical implant. The energy harvesting device includes piezoelectric elements arranged to generate a voltage in response to mechanical blood vessel activity such as bending, expansion or contraction of the blood vessel, or flow of blood through the blood vessel. The electrical energy generated by the piezoelectric elements may be used to recharge a battery, stored in a capacitor, and/or used in real time to generate the energy used for operation of the implant.

The present application claims the benefit of U.S. Provisional Application No. 61/078,409, filed Jul. 6, 2008.

### TECHNICAL FIELD OF THE INVENTION

The present invention relates to the field of systems and methods for supplying energy to medical implants using energy harvesting.

### BACKGROUND

Applicants' prior applications disclose intravascular devices used to deliver energy stimulus to the heart, or to nervous system structures such as nerves and nerve endings, and/or used to deliver agents into the bloodstream. See U.S. 2005/0043765 entitled INTRAVASCULAR ELECTROPHYSIOLOGICAL SYSTEM AND METHOD; U.S. 2005/0234431, entitled INTRAVASCULAR DELIVERY SYSTEM FOR THERAPEUTIC AGENTS; U.S. 2007/0255379 entitled INTRAVASCULAR DEVICE FOR NEUROMODULATION, U.S. Ser. No. 12/413,495 filed Mar. 27, 2009 entitled SYSTEM AND METHOD FOR TRANS VASCULARLY STIMULATING CONTENTS OF THE CAROTID SHEATH; and U.S. Ser. No. 12/419,717 filed Apr. 7, 2009 and entitled INTRAVASCULAR SYSTEM AND METHOD FOR BLOOD PRESSURE CONTROL.

FIG. 1 shows such one such system positioned in the vasculature. The illustrated system includes an elongate device body 12, one or more leads 14, and a retention device or anchor 16.

The leads may be used to electrically couple the device body 12 to elements 26 such as electrodes, ultrasound transducers, or other elements that will direct energy to target tissue. When they are to be used for delivering agents into the vasculature, the leads fluidly couple the device body to fluid ports such as valves, openings, or fluid transmissive membranes. Some leads might include sensors that are positioned for detecting certain conditions of the patient and for transmitting signals indicative of the sensed conditions.

The leads 14 are connected to the device body 12 which is also positioned in the vasculature. The device body houses a power source which may include a battery and a power generation circuit to produce operating power for energizing the leads and/or to drive a pump for delivery of agents and/or to operate the sensors. Where the implant is an electrical stimulator, the intravascular housing includes a pulse generator for generating stimulation pulses for transmission to the patient via electrodes on the leads and optionally via other electrodes directly on the body of the implantable device. A processor may be included in the intravascular housing for controlling operation of the device.

Some of the disclosed leads are anchored in blood vessels using expandable anchors 16 which may have stent-like or other suitable configurations. Stimulation elements such as the electrodes 26 may be carried by the anchor 16. As shown in FIG. 1, the anchors expand into contact with the vessel walls to maintain the position of the lead and to position electrodes 26 in contact with the vessel wall. Similar anchoring devices may be used to anchor the device body 12 if needed. The anchors include structural features that allow them to radially engage a vessel wall. For example, an anchor might comprise a band, sleeve, mesh, laser cut tubing, or other framework formed of one or more shape memory (e.g. nickel titanium allow, nitinol, thermally-activated shape-memory material, or shape memory polymer) elements or stainless steel, Elgiloy, or MP35N elements.

Energy harvesting devices use piezoelectric components to convert mechanical energy into an electrical charge which may be stored or used to drive an electrical device. Previous energy harvesting devices include those described in U.S. Pat. No. 6,407,484, U.S. Pat. No. 6,433,465, U.S. Pat. No. 6,737,789, U.S. Pat. No. 7,105,982, U.S. Pat. No. 7,331,803 and US 2008/0252174. Conversion of applied vibrational/acoustic energy into electrical stimulation energy in an implant is disclosed in U.S. 2006/0136004.

The present application discloses devices and methods in which intravascular components such as those described in the prior applications may be used to generate electrical energy using natural body movements.

### BRIEF DESCRIPTION OF THE DRAWINGS

FIG. 1 shows an intravascular implant having leads anchored in the internal jugular veins and an implant disposed in the inferior vena cava.

FIG. 2 is a block diagram illustrating an exemplary embodiment of an intravascular implant system having a battery that is rechargeable using harvested energy.

FIG. 3 is a perspective view of a first embodiment of an energy harvesting implant.

FIG. 4A schematically illustrates a second embodiment of an energy harvesting implant and associated system positioned in the vasculature. FIG. 4B is a transverse cross-section view of anchor portion of the implant of FIG. 4A.

FIG. 5 is a perspective view of the energy harvesting implant of FIG. 4A.

FIG. 6 is an end view of an alternative to the implant of FIG. 4A.

FIG. 7 is a perspective view showing another alternative to the implant of FIG. 4A.

FIG. 8 is a cross-sectional side view of a blood vessel showing, in cross-section, a third embodiment of an energy harvesting implant and associated system.

FIG. 9 is a perspective vies of the harvesting implant shown in FIG. 8.

FIG. 10 is a plan view of a flexible elongate device suitable for energy harvesting.

FIG. 11 is a cross-section view of the device of FIG. 10, with the components within the enclosures and portions of the flex regions omitted for clarity.

FIG. 12 schematically shows devices of the type shown in FIGS. 10 and 11 in various vessels within a human subject.

FIG. 13 shows a lead positioned in the vasculature of a human subject for use in harvesting energy for use by an implant.

FIGS. 14 and 15 show a cardiac lead positioned for both energy harvesting and electrophysiological sensing or stimulation.

### DETAILED DESCRIPTION

The present application discloses the use of intravascular implants to harvest mechanical energy from body movements and to convert the harvested energy to electrical energy that can be used for recharging secondary cells in the implant. Embodiments are shown and described with respect to use of the harvesting implants in an intravascular system for use in delivering electrical stimulation to nervous system or targets or tissue of the heart. However it is to be understood that these concepts may be used with other types of implants, including extra-vascular implants, without departing from the scope of the present invention.

In the system 100 shown in FIG. 2, implant device 12 houses a power source 11 which may include a battery and a power generation circuit to produce operating power stimulation. Device 12 also includes a pulse generator 13 for generating stimulation pulses for transmission to the patient via electrodes 26 on leads 14 and optionally via electrodes on the body of the implantable device 12. A processor 30 may be included for controlling operation of the device 12.

In one embodiment, the system 100 includes a battery 11 that is rechargeable. An energy harvesting implant 32 within the patient is electrically connected to a charging circuit 33 within the device 12 to recharge the battery. In another embodiment, energy harvested using the harvesting implant 32 may be stored in a capacitor, and/or it can be used in real time to generate the energy used for stimulation or to otherwise operate electrical or electronic components of the system 100. Circuitry used to convert the captured energy into useable or storable form is known to those of skill in the art and is not detailed in this application.

The energy harvesting implant may take a variety of forms. For example, energy harvesting implants might be incorporated into the intravascular implant device 12 itself, into one or more of the leads 14 or anchors 16, into another intravascular device, or into an extravascular implant or even an extracorporeal device.

The harvesting elements disclosed herein utilize piezoelectric elements that convert mechanical stress, strain, vibration, or bending into an electrical potential that can be used to provide operating power to components of the implant system or that can be stored in a capacitor or rechargeable battery for later use. Suitable piezoelectric materials include piezoelectric fiber composites, piezoelectric films, or piezoelectric ceramics. For many embodiments it is desirable to use flexible piezoelectric elements, such as flexible piezoelectric fiber composite elements, which generate an electrical charge when they are bent or flexed. The piezoelectric elements are positioned in electrical contact with electrodes and conductors that conduct the electrical energy to the device 12 for immediate use or for storage for later use.

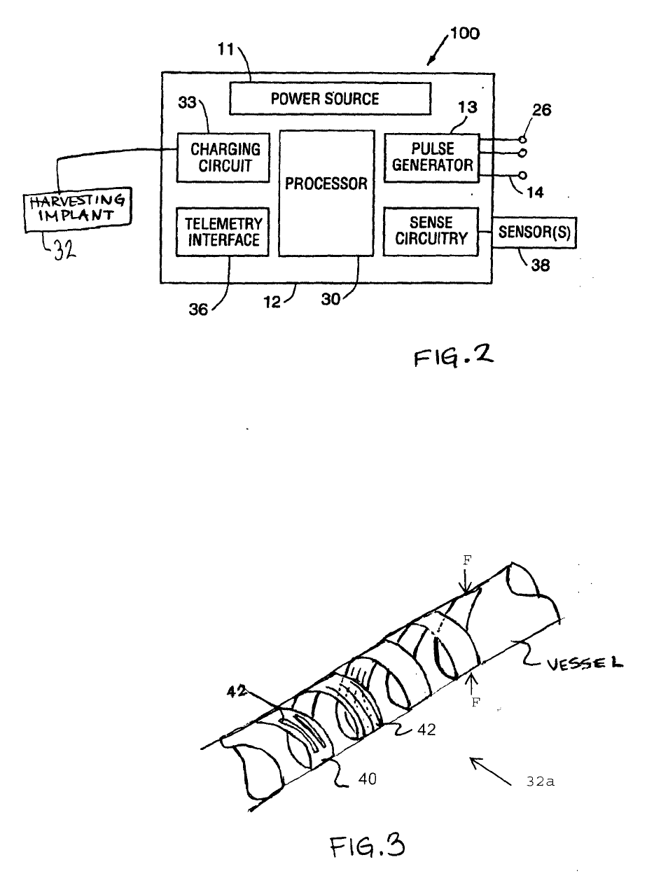

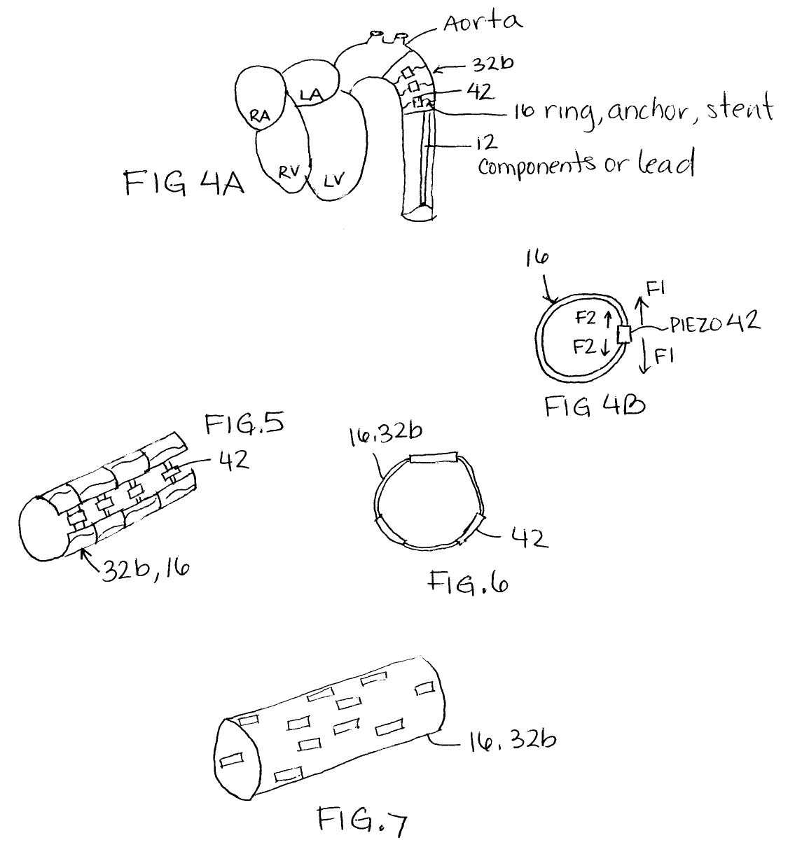

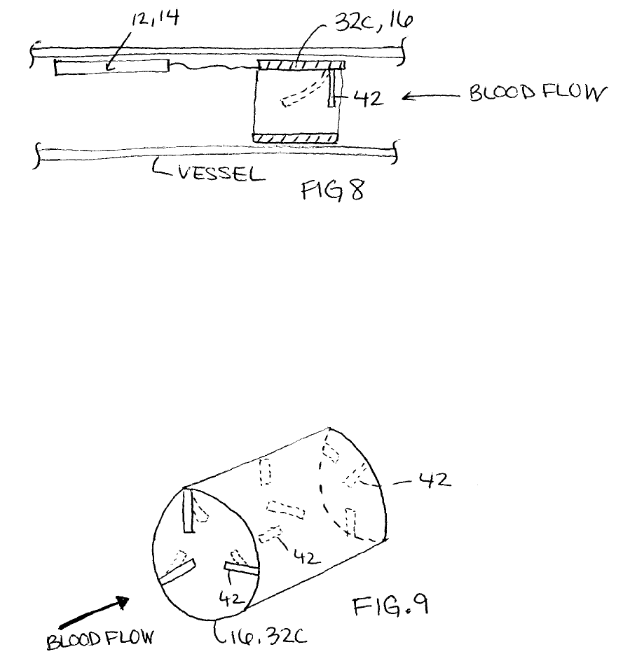

Referring to FIG. 3, energy harvesting implant 32a may be a coiled ribbon proportioned to line the inside of a blood vessel lumen. In this embodiment, the implant 32a harvests energy from the pulsing movement of the vessel itself. The implant 32a includes a ribbon 40 having piezoelectric elements 42. The ribbon may be formed of a piezoelectric composite which includes piezoelectric fibers as the piezoelectric elements 42, or piezoelectric elements may be positioned on or otherwise mounted onto a base ribbon substrate. The elements 42 are oriented so as to generate electrical potentials in response to the contracting movement of the vessel wall (see arrows F). For example, as shown in FIG. 3, the piezoelectric elements 42 can bend in response to the periodic reduction in vessel diameter resulting from vessel wall contraction. In other embodiments (including those discussed in connection with FIGS. 4-7), the piezoelectric material may be arranged to generate electrical current in response to strain during expansion of the vessel, or forces incurred when patient movement bends the vessel.

Electrodes (not shown) which may be positioned on the inner and/or outer surfaces of the ribbon, are connected to conductors that conduct the electrical energy from the piezoelectric elements to the device 12. The ribbon 40 may extend from one end of the device 12, or it may be coupled to a lead positioned remotely from the device 12. Suitable locations for the ribbon device include the larger vessels near the heart, including the aorta, inferior vena cava, superior vena cava, pulmonary artery and pulmonary vein.

As with many of the disclosed embodiments, the coiled ribbon 40 has a reduced diameter position in which the coiled ribbon 40 is positioned within a deployment sheath or catheter for passed into the vessel. Once within the vessel, the ribbon 40 is deployed from the sheath/catheter and expanded (actively or under its own radial forces) to an expanded position in contact with the vessel wall. In preferred embodiments, the outward radial forces of the coiled ribbon in the expanded position anchors the ribbon within the blood vessel.

The ribbon 40 may additionally carry stimulation electrodes for use in delivering therapeutic stimulation as described in the applications listed above.

FIGS. 4-7 illustrate an alternative embodiment which converts mechanical movement of blood vessel walls into electrical energy. As discussed in connection with FIG. 3, a cylindrical device that is placed in a blood vessel will experience radial stresses imparted to it from the contracting movement of the vessel walls. Certain vessels have walls with more muscle cells than other vessels. For example, arteries generally include more cells than veins. The more muscular vessels undergo significant contraction and expansion to assist in pumping blood. This cylindrical pumping action can impart strain to piezoelectric elements disposed on stents, anchors, rings, or other devices disposed in the vessels.

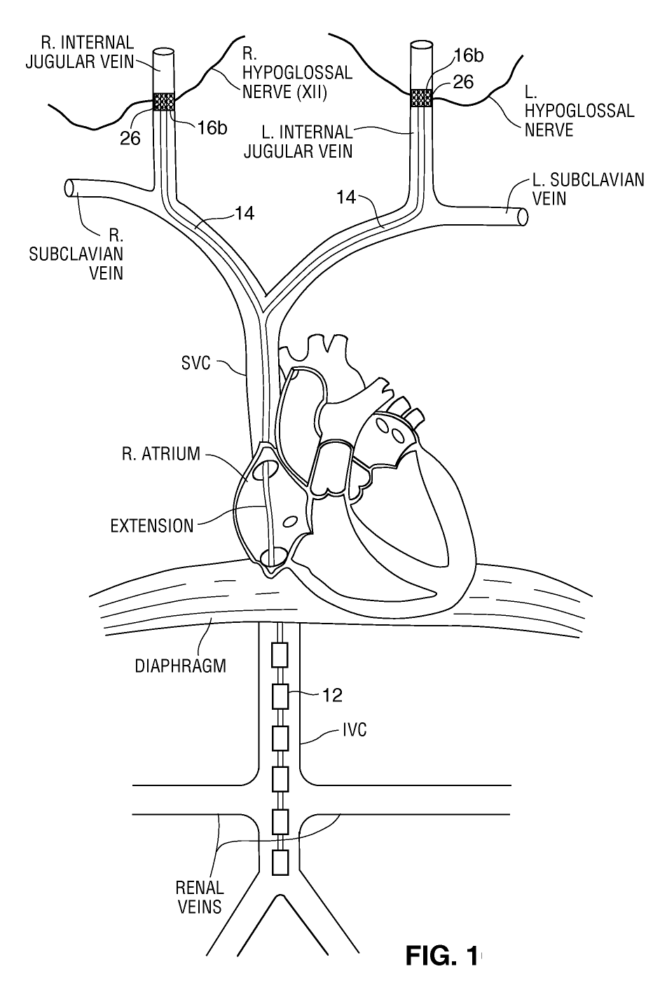

Referring to FIG. 4A, energy harvesting implant 32b includes a partially or fully annular device such as an anchor 16 (FIG. 1), stent, band, or ring positionable within a blood vessel. In one embodiment, the implant 32b is the anchor 16 used to retain the device 12 within the vasculature. In other embodiments, the implant 32b may be the anchor used to retain a lead 14 in the vasculature. The lead may be coupled to a device 12 such as a pulse generator as shown in FIG. 1. In either case, the harvested energy may be immediately converted (by electronics/circuitry on the anchor or in the device) to stimulation energy for delivery to surrounding tissue by electrodes on the anchor, lead, or device. Alternatively, the energy might be stored in a battery or capacitor for later use, or immediately used to power other electronic components needed for operation of the device. The FIG. 4A embodiment is shown positioned in the aorta, where the harvested energy might be converted to electrical energy used to stimulate surrounding baroreceptors or associated nervous system targets or structures using electrodes on the anchor 16 or lead 14.

Piezoelectric elements 42 are positioned on/in or mounted to the implant 32b. As shown in the cross-section view of FIG. 4B, the tubular body of the implant 32a may have clam-shell type arrangement when viewed in cross-section such that the piezoelectric elements are disposed between two edges of the surrounding implant material. For example, the body of the implant 32a may have a longitudinal gap or slot such that the piezoelectric elements are disposed within the gap or slot.

The elements 42 produce electrical energy due to stresses imparted by the implant against the elements 42 as the implant is compressed (arrows F1 in FIG. 4B) by vessel contraction. Alternatively, the elements 42 may produce electrical energy due to strain (arrows F2) imparted against the elements 42 as the implant re-expands following a vessel contraction. Elements 42 may be axially positioned along the wall of the implant as in FIG. 5, or circumferentially as in FIG. 6, or both axially and circumferentially as in FIG. 7.

FIGS. 8 and 9 show another embodiment in which the energy harvesting implant 32c may be a stent or anchor 16 used to support the device 12 or a lead 14 in the vasculature. In this embodiment, blood flowing through the implant 32c imparts bending forces against a cantilever piezoelectric element 42 extending into the lumen of the implant 32c. The piezoelectric fibers or crystals of the piezoelectric element generate an electric potential in response to the bending of the element 42 by flowing blood. In one embodiment, the element 42 remains strained due to the constant flow of blood within the vessel, but it pulses with the blood flow and thereby generates a voltage with each pulse of the flowing blood.

In the FIG. 4A-9 embodiments, the energy harvesting implant may be a stent-like device in the form of a band, sleeve, mesh, laser cut tubing, or other framework formed of one or more shape memory elements (e.g. nickel titanium allow, nitinol, thermally-activated shape-memory material, or shape memory polymer) or stainless steel, Elgiloy, or MP35N elements. It should be noted that while “stent-like” implants or anchors resemble stents in the sense that they are expandable so as to radially engage a vascular wall, these implants or anchors need not have the hoop strength possessed by conventional stents as needed by such stents to maintain patency of the diseased vessels within which they are conventionally implanted.

Devices similar to those of FIGS. 4-9 may be modified for use in other lumens of the body, such as the intestinal lumens wherein peristaltic movements can be converted to electrical energy. In a further modification to the devices of FIGS. 4-9, a cuff having piezoelectric elements may be positioned surrounding a blood vessel or another lumen such as an intestinal lumen. This type of embodiment may be particularly suitable where the device 12 is an extravascular device such as a subcutaneous pulse generator of the type used for conventional pacemakers or ICDs, or an extravascular drug delivery device, or other types of extravascular therapeutic or diagnostic devices.

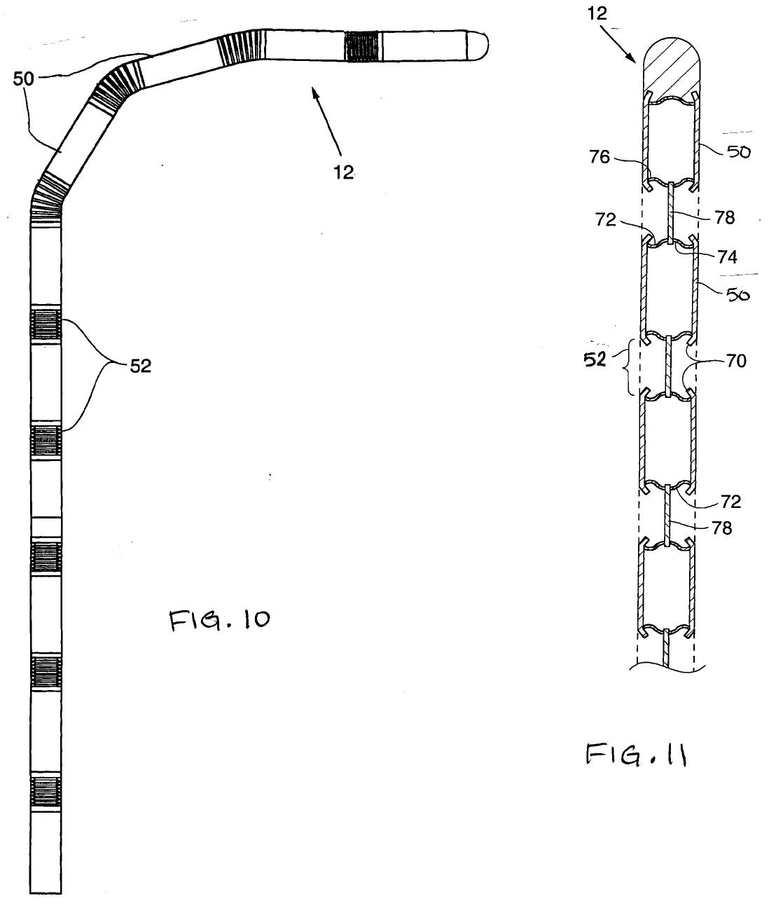

Some intravascular devices such as device 12 may contain flexible joints or interconnects that allow the device to flex between more rigid segments of the device. Configurations of this type are shown and described in Applicant's U.S. Pat. No. 7,363,082, entitled FLEXIBLE HERMETIC ENCLOSURE FOR IMPLANTABLE MEDICAL DEVICES, and in Applicant's U.S. Application No. U.S. 2005/0043765 entitled INTRAVASCULAR ELECTROPHYSIOLOGICAL SYSTEM AND METHOD. For example, as shown in FIG. 10, multiple rigid sealed enclosures 50 may be connected by flex regions 52, some of which are shown in a flexed position. The rigid containers can be used to contain electronic components, electromechanical parts or assemblies to form sophisticated implantable device. Components with separate containers can be operatively coupled to one another using cabling, flex circuits or other types of interconnects extending between the segments. The flex regions 52 may be enclosed using flexible silicone, hermetic bellows structures, or other structural elements designed to protect the interconnects while allowing bending at the interconnects as shown in FIG. 10.

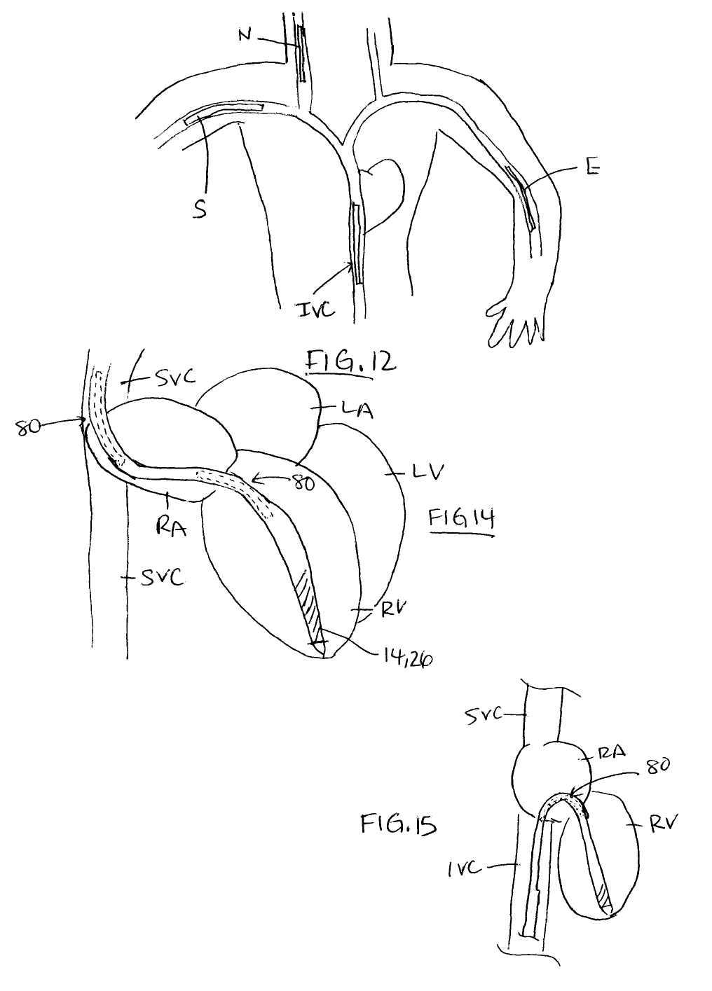

FIG. 11 shows the device 12 in partially-constructed form and without the electrical and electronic components, so that the mechanical elements can be more easily seen. As shown, couplers 72 are secured (e.g. by welding or similar techniques) within the enclosures 50, near the ends 70. Hinge regions 52 lie between the enclosures and are sealed against body fluids as discussed. One or more piezoelectric elements 78 are joined to the coupler 72 to form a mechanical assembly that mechanically links a pair of adjacent enclosures 50. Moreover, since the elements 78 bend in response to flexion of the device at the flex regions 52, the piezoelectric crystals/fibers/films etc. on the elements 78 produce an electric potential in response to bending, allowing the bending to be converted to electrical energy for immediate or later use by the system. In alternative designs, the piezoelectric elements may be included on flexible tubular housings extending between the enclosures 50 in addition to or as an alternative to being on enclosed interconnecting members.

Wherein the device is positioned into the inferior vena cava as shown in FIG. 1, natural abdominal movement and breathing can result in flexion of the device. Other suitable locations which allow harvesting based on gross body movements include the neck region N (e.g. in a jugular vein or carotid), at the region of the shoulder joint S (e.g. at the subclavian or cephalic vein), the region of the elbow joint E (e.g. the median cubital vein in the region of the inner elbow), or joints of the lower body. Leads are schematically illustrated in regions N, S and E, as well as in the inferior vena cava, in FIG. 12.

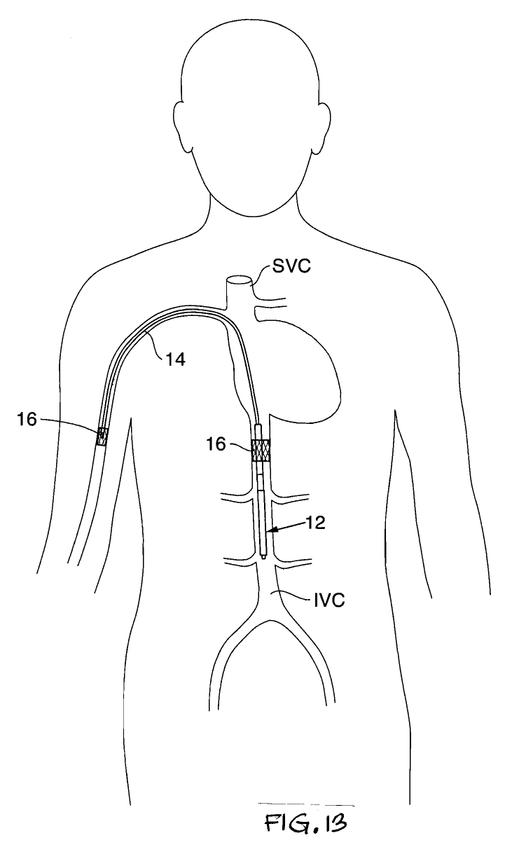

FIGS. 10 and 11 show the device body 12 itself as including the piezoelectric elements that receive bending forces for energy harvesting. However, such elements may be similarly positioned within elongate leads that are used to conduct stimulus or agents to the body, or those that connect two or more interconnected operative components of the system (e.g. the device 12 and a peripheral component through which inductive recharging is carried out, or into which agent is percutaneously injected for refilling a drug delivery device). In other embodiments, the lead may be one that extends to locations for the sole purpose of energy harvesting. See FIG. 13, for example, in which a lead 14 extending through the shoulder region may be used for energy harvesting through flexing of the lead. This embodiment may be modified to include additional leads positioned elsewhere in the vasculature for use in delivering stimulation or agents, and/or it might include a peripheral access point into the peripheral lead for inductive recharging (using an extracorporeal device) or drug refilling.

Energy harvesting implants converting bending energy from gross motor movements at the joints (hips, elbows, shoulders, knees, etc) may be modified for extravascular use and even for extracorporeal use.

Leads used both for delivery of stimulus and for energy harvesting through flexing may be alternatively positioned in the heart. Current ICD and pacemaker leads placed in the heart for stimulation and/or sensing experience flexing with every beat of the heart. The motion from each beat can be harvested and turned into electrical voltage by including piezoelectric elements in or on the leads 14, especially at points along the length of the lead that will experience relatively large amounts of flexion. Suitable high flex points 80 include the transition between the superior vena cava (SVC) and the right atrium (RA) or between the RA and the right ventricle (RV) as in FIG. 14. Another lead location experiencing large amounts of flexion at a high flex point 80 extends from the IVC into the RA as in FIG. 15, among others. The leads are coupled to an intravascular device body 12 (FIG. 1) or to a more conventional subcutaneous ICD or pacemaker can.

Energy harvesting components may be hardwired to the devices that are to receive the harvested energy, or inductive coupling might instead be used to transmit the harvested energy to other parts of the implanted system. Use of inductive coupling would additionally allow the use of energy harvested from extravascular locations, including those mentioned above. As other examples, piezoelectric elements may be positioned to extend between adjacent ribs in the intercostal space, so as to harvest and convert the mechanical forces imparted on the elements by rib expansion during breathing. Breathing movements may also be harvested using piezoelectric elements positioned to generate electric potential in response to movement of the diaphragm during breathing. As another example, piezoelectric elements may be coupled to muscles or tendons/ligaments to harvest energy from lengthening or shortening of the muscles during voluntary (or involuntary) muscle movements. A subcutaneous piezoelectric element (or a surface patch or shoe insert) at the sole of the foot can be used to harvest foot/heel strike energy. A patch having a piezoelectric element may be placed on the heart so that rocking or bending of the element in response to beating of the heart will generate electrical energy.

All prior patents and applications referred to herein are incorporated by reference for all purposes.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

We claim:

1. An energy harvesting implant positionable within a blood vessel having a vessel wall, comprising;
an implant device proportioned for positioning within the blood vessel;
at least one piezoelectric element disposed on the implant device, the piezoelectric element positioned to receive mechanical forces in response to blood vessel activity and to thereby produce a voltage.

2. The energy harvesting implant of claim 1, wherein the piezoelectric element is positioned to receive bending forces in response to blood vessel activity and to produce the voltage in response thereto.

3. The energy harvesting implant of claim 2, wherein the implant device includes an elongate device body having at least one flexible region bendable in response to bending of the blood vessel, and wherein the piezoelectric element is positioned at the flexible region of the elongate device body.

4. The energy harvesting implant of claim 2 wherein:
the implant device is a tubular device having a lumen, the tubular device expandable into contact with the blood vessel wall; and
the piezoelectric element extends into the lumen and is bendable in response to pulsing of blood flow through the vessel.

5. The energy harvesting implant of claim 2, wherein:
the implant device is a tubular device having a wall positionable in contact with the blood vessel wall, the tubular device moveable to a compressed position in response to contraction of the blood vessel; and
the piezoelectric element is positioned to receive mechanical forces in response to contraction and/or expansion of the blood vessel wall and to thereby produce a voltage.

6. The energy harvesting implant of claim 5 wherein the piezoelectric element is positioned on the tubular device such that movement of the tubular device to the compressed position results in application of compressive forces against the piezoelectric element.

7. The energy harvesting implant of claim 5 wherein the piezoelectric element is positioned on the tubular device such that movement of the tubular device to the compressed position results in application of bending forces to the piezoelectric element.

8. The energy harvesting implant of claim 5 wherein the tubular device is moveable to an expanded position in response to expansion of the blood vessel, and wherein the piezoelectric element is positioned on the tubular device such that movement of the tubular device to the expanded position results in application of strain to the piezoelectric element.

9. The energy harvesting implant of claim 2, wherein the implant device is a coiled ribbon having an outer surface positionable in contact with the blood vessel wall.

10. The energy harvesting implant of claim 9 wherein the coiled ribbon is formed of a piezoelectric fiber composite material.

11. The energy harvesting implant of claim 2 wherein at least a portion of the energy harvesting implant is configurable in a radially compressed position so as to be positioned in a blood vessel, and configurable in a radially expanded position to retain the energy harvesting implant within the blood vessel.

12. A method of harvesting mechanical energy from a blood vessel for use in a medical implant, the method comprising:
positioning an implant device within a blood vessel, the implant device including at least one piezoelectric element, wherein the piezoelectric element receives mechanical forces in response to blood vessel activity and thereby produces a voltage.

13. The method of claim 12, wherein the piezoelectric element bends in response to bending of the blood vessel and thereby produces a voltage.

14. The method of claim 12, wherein the piezoelectric element is compressed in response to contraction of the blood vessel and thereby produces a voltage.

15. The method of claim 12, wherein the piezoelectric element is stretched in response to expansion of the blood vessel and thereby produces a voltage.

16. The method of claim 12 wherein strain is imparted to the piezoelectric element in response to expansion of the blood vessel and thereby produces a voltage.
